(19) United States
(12) Patent Application Publication
(10) Pub. No.: US 2005/0243841 A1
(43) Pub. Date: Nov. 3, 2005

(54) Tone disabling in a media gateway

(75) Inventor: Peter Goldstein, Thalwil (CH)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS SCHWEIZ AG, ZUERICH (CH)

(21) Appl. No.: 10/983,013

(22) Filed: Nov. 8, 2004

(30) Foreign Application Priority Data
May 1, 2004 (EP) 04 010 392.1

(51) Int. Cl. H04L 12/56

(52) U.S. Cl. 370/401; 370/352

(57) ABSTRACT

Fax and modem connections are usually treated in the same way as voice connections by the network nodes during connection setup. By using the disabling tone, fax modems having integrated echo compensation deactivate echo compensators which are provided on the network side. Packet-switched transport networks are generally unable to transmit this tone perfectly. In order to regain the full functionality of a circuit-switched network, a media gateway is proposed which contains a tone disabler, a tone generator and an additional tone disabler, which allow an echo compensator to be controlled in the direction of the packet network and allow both an echo compensator to be controlled in the direction of the circuit-switched network and the disabling tone to be reproduced in the direction of the circuit-switched network.

### CROSS REFERENCE TO RELATED APPLICATIONS

The present application claims priority to European patent application EP04010392.1 filed 05.01.2004, which is herein incorporated by reference.

### BACKGROUND OF THE INVENTION

The present invention relates to a method for controlling the tone disabling in a media gateway. Instead of using a non-specialist terminology in the following, the English-language nomenclature from the ITU-T and IETF standards is used, e.g. “media gateway”, “tone disabler” or “tone disabling”. This makes it possible to avoid ambiguities. At the end of this document is a list of the abbreviations and terms which are used, said list being an integral part of this document.

The present invention relates to the sphere of fax/modem transfer and/or data transfer in the voice band and to the sphere of voice traffic. A TDM-based circuit-switched network such as ISDN, for example, offers a very high quality of service. The network operators are implementing an IP-based packet-switched network, which is also increasingly used for real-time applications such as e.g. voice and data in the voice band, both in the so-called backbone network and in the access network. A gateway allows the TDM ←→ IP or POTS ←→ IP conversion.

FIG. 1 shows a typical configuration of a media gateway. The connection between a circuit-switched network TDM and a packet-switched network IP (RTP) is provided by a media gateway 20 for the payload information (e.g. voice, fax/modem). Because a part of the transmission route is implemented using a packet-switched network, the transmission of single-frequency and multifrequency inband signals is not generally supported without further measures.

Fax and modem connections are usually treated in the same way as voice connections by the network nodes during connection setup (connection control logic, echo control logic). If echo sources and propagation times >20 ms are present, echo suppression devices (e.g. echo compensators) are inserted in the connection. By using the so-called disabling tones (2100 Hz, with phase jump) as a reply signal from the called to the calling fax device, fax modems having integrated echo compensation deactivate the echo compensators which are provided on the network side. Therefore a so-called tone disabler or a tone disabling function must be integrated in the echo compensators. Since the disabling tone is only sent from the called fax device in the direction of the calling fax device, the echo compensators must be able to recognize this disabling tone on both the send path and the receive path. This requirement results in the following difficulties:

i) Error-free transmission of this disabling tone is not possible on IP-based transport networks due to packet loss, jitter buffer manipulations or use of low bit rate codecs.

ii) The switch between voice and fax within the same connection requires a tone disabler in the media gateway, which tone disabler also recognizes the disabling tone from the IP side for the deactivation of the echo compensator during the fax transmission, and which also recognizes the end of the fax transfer (e.g. by means of level evaluation) and therefore reactivates the echo compensator for the subsequent voice transfer as applicable.

iii) The disabling tone (reply signal) must be sent all the way to the calling fax device, in order that any further echo compensators which may be present can evaluate the disabling tone.

The requirement listed above in ii) is particularly significant in the context of a confidential fax transfer. A voice connection is first established from the A subscriber to a site having a fax device, and the A subscriber ascertains by means of a conversation that the replying B subscriber at the fax device is precisely that person who is authorized to receive a fax message. Once this is established, the fax device is activated by the A subscriber in the same connection, and the fax message is transferred in the voice band in the usual manner.

The difficulties listed under i) to iii) were previously solved as follows: The document RFC2833 describes a method in which the media gateway does not transport the inband single-frequency and multifrequency signals as audio signals via IP, but recognizes them on the TDM side and transmits them as follows:

a) as encoded tone/signal information (e.g. significance, signal strength, duration) or

b) as an event (e.g. dial tone=66, cf. RFC 2833).

In the known implementations, the disabling tone which is transferred in accordance with the standard RFC2833 is only used for deactivating the echo compensator. This has the following consequences:

i) this does not correspond to the tone disabling (but rather to external disabling) and

ii) this does not include the sending of the disabling tone.

### SUMMARY OF THE INVENTION

The present invention therefore addresses the problem of specifying a method for controlling the tone disabling in a media gateway, and a media gateway for carrying out said method, wherein the above listed disadvantages of the known implementations, said implementations being based on the standard RFC2833, are avoided when transmitting data in the voice band, thereby achieving an equivalent functionality in comparison with a pure TDM network. This equivalent functionality is essential in order to allow the fax and data services in all their variants, even when parts of the transport network are designed as packet-switched networks such as e.g. an IP network.

Advantageous configurations of the invention are specified in further claims.

In accordance with the claimed method, wherein
for each connection in the direction of the packet-switched network, a tone disabler for deactivating the echo compensator is provided, and
for each connection in the direction of the circuit-switched network, a tone generator (60) for generating a disabling tone is controlled using the encoded signal information which is analyzed in the payload analyzer, and a further tone disabler is connected downstream of the tone generator in order to deactivate the echo compensator, the tone disabling is performed correctly in the direction of the circuit-switched network TDM, and a disabling tone is actually sent. This is particularly significant since a switch from voice to data or vice versa is thus enabled within one and the same connection.

### BRIEF DESCRIPTION OF THE SEVERAL VIEWS OF THE DRAWINGS

An exemplary embodiment of the invention is explained in further detail below with reference to the drawings, in which:

FIG. 1 shows a media gateway including an echo compensator which is controlled in accordance with the prior art; and

FIG. 2 shows a media gateway including an echo compensator which is controlled in accordance with the present invention.

### DETAILED DESCRIPTION OF THE INVENTION

It is assumed that the IP network exceeds a certain packet-loss probability or that the encoder/decoder which is intended for use is not suitable for the transport of single-frequency or multifrequency signals. In addition, the standard RFC2833 is used for the transmission of tones/signals.

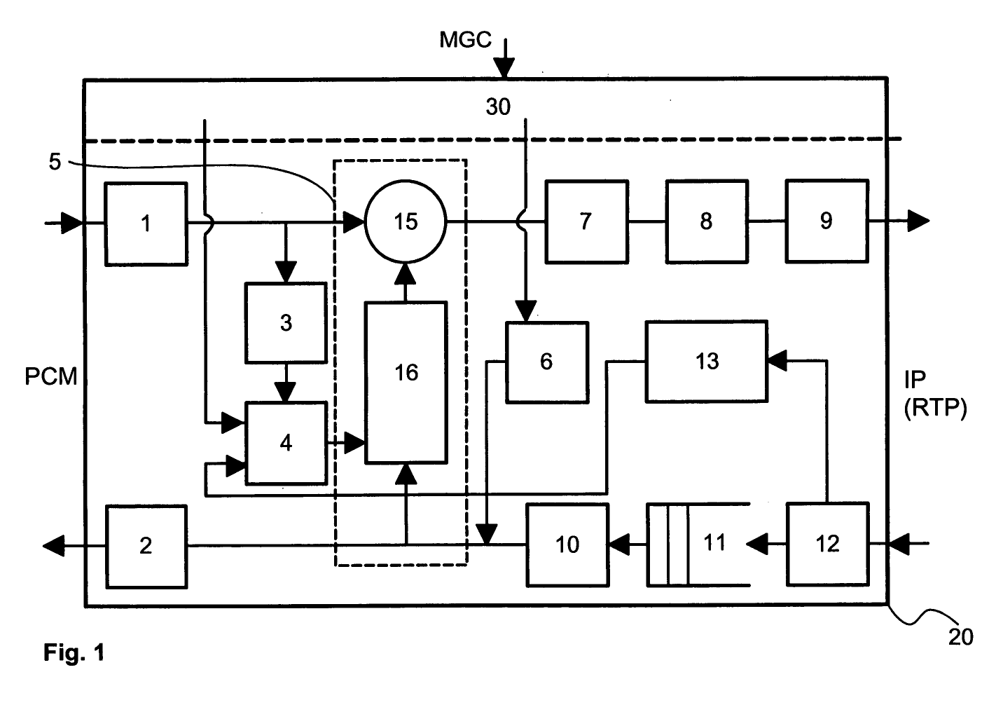

FIG. 1 shows a media gateway 20 in accordance with the prior art, said media gateway being arranged between a circuit-switched network, e.g. TDM or POTS, and a packet-switched network IP. The echo compensator 5 is activated or deactivated (“enable”/“disable”) by an external echo compensation control 4. In this case, the external sources or information for controlling the echo compensator come from a media gateway controller MGC or from the “encoded signal information” which is provided by the packet-switched network IP. This “encoded signal information” is evaluated in the analyzer 13 (payload analyzer RFC 2833) and the deactivation signal is derived therefrom. Prior to this, a separation of payload and signal packets takes place in the RTP decoder 12. The other usual components of a media gateway 20 are illustrated in FIG. 1 as follows, namely:

Decoder 1

The decoder 1 converts TDM-based payload signals, which have been encoded in accordance with G.711, into a linear representation.

Voice Activity Detector 7

The voice activity detector detects voice pauses and is only active during a voice communication.

Encoder 8

The information is encoded in the encoder 8 in accordance with the current encoding method.

RTP Encoder 9

The RTP encoder packets and manages the transport of the encoded information.

RTP Decoder 12

The RTP decoder depackets the information which is transmitted via RTP.

Payload Analyzer 13

The payload analyzer recognizes and analyzes the information, the payload type indicates that it is audio, text, etc., but not which signal.

Jitter Buffer 11

The jitter buffer stores the incoming IP packets and equalizes the different propagation times, which are caused by the IP network, of the IP packets.

Decoder 10

The decoder decodes, i.e. generates the linear representation of the encoded payload information, e.g. in accordance with G.711, G.7xx.

Tone Detector 3

A tone detector (2100 Hz with/without phase jump) detects that a data connection is waiting to be dealt with in the voice channel.

Tone Generator 6

The tone generator 6 generates the normal DTMF and switching tones. The tone generator 6 obtains the information for generating the aforementioned specific tones from a table, for example.

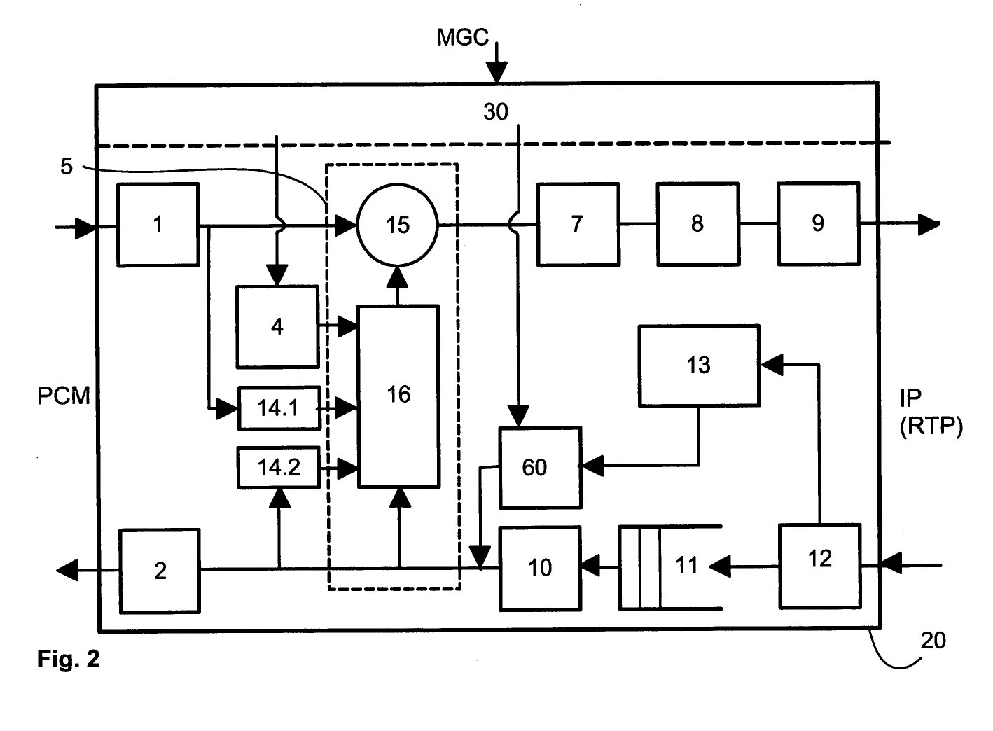

A connection between two fax devices is now considered wherein the connection is managed via a media gateway 20 in accordance with the invention. For this, reference is made to FIG. 2 in the following. This media gateway 20 in accordance with the invention differs from the prior art in the circuit-switched network TDM→packet-switched network IP direction, in that it includes not simply a tone detector 3 but a tone disabler 14.1.

In comparison with the prior art, the claimed media gateway 20 also includes provision for a tone generator 60 which is connected to the payload analyzer 13: if the payload analyzer 13 of the media gateway 20 which is currently being considered now detects the disabling tone, the tone generator 60 within the same media gateway 20 is instructed to send this tone (onward in the direction of the TDM network). In accordance with the standard ITU-T Rec. G.168, this tone has a frequency of f=2100 Hz (for the deactivation of echo suppressors) and a phase jump if applicable (for the deactivation of echo suppressors and echo compensators). In this way, any additional echo compensators in the connection, i.e. on the TDM side, can detect the disabling tone. A tone disabler 14.2 which is now additionally inserted in the media gateway 20 detects the disabling tone and the echo compensator 5 is consequently deactivated (=“disabled”) for the duration of the fax transmission. The tone disabling is terminated at the end of the fax transmission, so that the echo compensator 5 can again receive the status which is indicated by the external disabling. This external disabling is achieved by transferring the corresponding control information from the media gateway controller MGC via the media gateway-internal control 30 to the echo compensation control 4.

A signal level evaluation which is contained in the tone disabler 14.1/14.2 allows the end of the fax transfer to be detected. A voice communication with activated echo compensation is therefore possible in the same connection.

The tone disabling occurs whenever there is a switch from voice communication to data communication (such as e.g. fax or modem operation), and ceases automatically when there is a switch back to voice. An intermediate pause characterizes the end of the data transmission in this case.

In the illustration according to FIG. 2, provision is made for two tone disablers 14.1 and 14.2. In a real implementation, however, provision can be made for a single tone disabler 14 with two corresponding inputs.

The following is a list of abbreviations used in the specification:

DTMF Dual Tone Modulation Frequency

IETF Internet Engineering Task Force

IP Internet Protocol

ISDN Integrated Services Digital Network

ITU International Telecommunication Union

ITU-T Telecommunication Standardization Sector of ITU

MGC Media Gateway Controller

POTS Plain Old Telephone System

PSTN Public Switched Telecommunication Network

RTP Real Time Protocol

TDM Time Division Multiplex

The following documents referred to above, are herein incorporated by reference:

ITU-T Rec. G.168;

Digital network echo cancellers (6/2002);

ITU-T G.711;

Pulse Code Modulation (PCM) of voice frequencies

ITU-T G.723;

Speech codecs: Dual rate speech codec for multimedia communications transmitting at 5.3 and 6.3 kBit/s;

ITU-T G.729;

Coding of speech at 8 kBit/s using CS-CELP;

RFC 2833;

Network Working Group, H. Schulzrinne;

Request for Comments: 2833, Columbia University;

Category: Standards Track, S. Petrack;

MetaTel May 2000; and

RTP Payload for DTMF Digits, Telephony Tones and Telephony Signals.

1. A method for controlling the tone disabling for an echo compensator included in a media gateway which is inserted between a circuit-switched network and a packet-switched network, wherein voice and data are managed in the voice band via the media gateway, wherein:
for each connection in the direction of the packet-switched network, inband signals are detected and the inband signals are transmitted as encoded signal information for setting the tone disabling;
for each connection in the direction of the circuit-switched network, provision is made in the media gateway for the arrangement of a payload analyzer for the purpose of supplying encoded signal information for deactivating the echo compensator; characterized in that
for each connection in the direction of the packet-switched network, a tone disabler is provided for deactivating the echo compensator, and that
for each connection in the direction of the circuit-switched network, a tone generator for generating a disabling tone is controlled using the encoded signal information which is analyzed in the payload analyzer, and a further tone disabler is connected downstream of the tone generator in order to deactivate the echo compensator.

2. The method according to claim 1, wherein the tone generator generates the disabling tone in addition to the DTMF and switching tones.

3. The method according to claim 2, wherein the disabling tone which is generated by the tone generator has a frequency of f=2100 Hz.

4. The method according to claim 1, wherein the additional tone disabler for controlling the echo compensator performs a signal-level evaluation of the encoded signal information.

5. The method according to claim 1, wherein the tone disabler, by means of which inband signals are detected for each connection in the direction of the packet-switched network, and the additional tone disabler are designed as a single unit.

6. The method according to claim 1, wherein the echo compensator is deactivated for the duration of a data connection and that, at the end of a data connection, the echo compensator is reset to the status it had at the start of the data connection.

7. The method according to claim 6, wherein a switch from voice to data within a connection is effected by means of the tone disabling.

8. The method according to claim 2, wherein the additional tone disabler for controlling the echo compensator performs a signal-level evaluation of the encoded signal information.

9. The method according to claim 3, wherein the additional tone disabler for controlling the echo compensator performs a signal-level evaluation of the encoded signal information.

10. The method according to claim 4, wherein the tone disabler, by means of which inband signals are detected for each connection in the direction of the packet-switched network, and the additional tone disabler are designed as a single unit.

11. The method according to claim 5, wherein the echo compensator is deactivated for the duration of a data connection and that, at the end of a data connection, the echo compensator is reset to the status it had at the start of the data connection.

12. The method according to claim 12, wherein a switch from voice to data within a connection is effected by means of the tone disabling.
